(19) United States
(12) Patent Application Publication
(10) Pub. No.: US 2020/0045663 A1
(43) Pub. Date: Feb. 6, 2020

(54) TRANSMITTER AND RECEIVER COMMUNICATION DEVICE FOR A WIRELESS COMMUNICATION NETWORK

(71) Applicant: Huawei Technologies Duesseldorf GmbH, Duesseldorf (DE)

(72) Inventors: Konstantinos MANOLAKIS, Munich (DE); Wen XU, Munich (DE)

(21) Appl. No.: 16/594,676

(22) Filed: Oct. 7, 2019

Related U.S. Application Data
(63) Continuation of application No. PCT/EP2017/058351, filed on Apr. 7, 2017.

(51) Int. Cl. H04W 56/00

(52) U.S. Cl. CPC H04W 56/0015; H04W 92/18

(57) ABSTRACT

A transmitter communication device configured for communication with a receiver communication device in a wireless communication network is provided. The transmitter communication device comprises a processor configured to provide basic synchronization information by generating a communication frame comprising at least a first signal and a second signal for synchronising the receiver communication device. The processor is further configured to provide additional synchronization information on the basis of the first and/or the second signal by: arranging at least the first signal and the second signal in a pre-defined configuration in the communication frame; and/or by selecting the first and the second signal from a set of pre-defined synchronization signals that differ in a generating code. Moreover, the invention relates to a corresponding receiver communication device.

### CROSS-REFERENCE TO RELATED APPLICATIONS

This application is a continuation of International Application No. PCT/EP2017/058351, filed on Apr. 7, 2017, the disclosure of which is hereby incorporated by reference in its entirety.

### TECHNICAL FIELD

Generally, embodiments of the present invention relate to the field of wireless communications. More specifically, embodiments of the present invention relate to a transmitter communication device and a receiver communication device for a wireless communication network, wherein the transmitter communication device is configured to serve as a synchronization reference for the receiver communication device.

### BACKGROUND

Direct device-to-device (D2D) communication is envisioned as a key component for future 5G networks. For safety and emergency applications, as often met in vehicle-to-anything (V2X) communications, ultra-reliable low-latency communication (URLLC) must be provided to mobile users. Therefore, fast and reliable time synchronization, user identification and link establishment are required especially in the sidelink, including any type of multi- or single-link D2D/V2V (vehicle-to-vehicle) communication (unicast, broadcast etc.). In the LTE sidelink, which is considered as the oncoming technology to serve D2D/V2V cellular-based communication, receiver-side synchronization is performed through the detection of a set of predefined synchronization sequences. Usually, these predefined synchronization sequences also provide the user ID of the transmitter, which serves as a synchronization reference to the receiver.

A typical scenario of a mobile (e.g. vehicular) network in a cellular environment includes in- and out-of cellular coverage user equipments (UEs), some of which may be equipped with a Global Navigation Satellite System (GNSS) receiver. Coexistence of so-called in-band sidelink and cellular transmissions within a frequency band requires time alignment of all transmitted signals to avoid interference enhancement between links. Thus, time synchronization between the network nodes, including enhanced Node Bs (eNBs), relays/road side units (RSUs), sidelink-capable UEs and other cellular UEs is required. Similar synchronization requirements apply among multiple D2D radio links, even if the sidelink occupies a dedicated band (out-of-band D2D), other than the one used for cellular uplink/downlink transmission.

Fast and reliable receiver-side synchronization and link establishment is needed in the sidelink. Similar to the downlink, UEs need to perform time synchronization and estimate—through reception of sidelink synchronization signals—the so-called Beginning of Frame (BOF) and Beginning of Symbol (BOS) in order to correctly process the received signal, e.g. remove the Cyclic Prefix (CP) in an Orthogonal Frequency Division Multiplexing (OFDM) system. Typically, UEs perform simultaneously coarse frequency synchronization as well as estimate and compensate the Carrier Frequency Offset (CFO) between the transmitter and receiver oscillators.

Furthermore, sidelink UEs share their time reference through sidelink synchronization signals. By receiving and detecting these signals, even out-of-coverage UEs are able to synchronize and align their transmissions in time with respect to other -already synchronized- or in-coverage users. Of course, in order to properly evaluate, prioritize and potentially combine the time references of all received sidelink signals, each receiving UE needs to know the type of the time reference the transmitting users follow, e.g. a reference instructed by their base station, GNSS, other in- or out-of coverage UEs etc. By missing this information, UEs may be following a suboptimal time reference, or observe different references and may be unable to properly select the most relevant one on the basis of, for instance, a hierarchical synchronization/prioritization scheme.

Thus, there is a need for improved devices and methods in a wireless communication network allowing for improved synchronization, in particular a hierarchical synchronization using more than one type of synchronization sources possibly following different time references.

### SUMMARY

Embodiments of the invention provide improved devices and methods in a wireless communication network allowing for improved synchronization, in particular a hierarchical synchronization using more than one type of synchronization sources possibly following different time references.

The foregoing and other aspects are achieved by the embodiments described herein. Further implementation forms are apparent from the dependent claims, the description and the figures.

According to a first aspect embodiments relate to a transmitter communication device configured for communication with a receiver communication device in a wireless communication network, wherein the transmitter communication device comprises a processor configured to provide basic synchronization information by generating a communication frame comprising at least a first signal and a second signal for synchronizing the receiver communication device. The processor is further configured to provide additional synchronization information on the basis of the first and/or the second signal by arranging at least the first signal and the second signal in a pre-defined configuration in the communication frame; and/or by selecting the first and the second signal from a set of pre-defined synchronization signals that differ in a generating code (in particular generating sequence).

Thus, the transmitter communication device according to the first aspect advantageously provides additional synchronization information on the basis of at least one of two additional “information dimensions”, namely by the combination of positions of the first and second signal within the communication frame and/or by the combination of generating codes used for the first and second signal. The communication frame can comprise the “usual” information dimensions of time, frequency and space (beamforming using multiple antennas). To this end, the transmitter communication device can be configured to multiplex the first and second signal in the communication frame in time, frequency and/or space.

In different implementation forms the first signal and/or the second signal can be, for instance, reference signals, pilot signals and/or synchronization signals. In an implementation form the communication frame can comprise more than two signals, for instance, three signals, which are chosen from a set of pre-defined synchronization signals comprising a first and a second synchronization signal. In an implementation form the set of pre-defined synchronization signals comprises two or more than two pre-defined synchronization signals. The pre-defined synchronization signals can be based on LTE primary synchronization signals. In an implementation form the set of pre-defined synchronization signals can depend on the receiver communication device, i.e. the transmitter communication device can use a different set of pre-defined synchronization signals for different receiver communication devices.

The transmitter communication device and/or the receiver communication device can be, for instance, a user equipment or a base station of the wireless communication network. The wireless communication network can be, for instance, a cellular communication network, an assisted network or an ad-hoc network. The transmitter communication device and the receiver communication device can be configured to communicate, for instance, in an uplink, downlink and/or sidelink direction. To this end, the transmitter communication device can comprise a communication interface configured to transmit the communication frame to the receiver communication device.

Thus, embodiments of the invention allow generating advanced synchronization sequences, which are capable of carrying additional synchronization information providing more than a user/transmitter identifier (user-ID), as in the case of sequences used for conventional LTE synchronization signals. Such additional synchronization information may include the type of the synchronization source reference of the transmitter communication device (such as base station/cellular network, GNSS etc.), the number of hops over which the transmitter communication device has received its synchronization reference or other information. This additional synchronization information can be used beneficially by the receiver communication device for prioritizing and weighting synchronization signals received by the receiver communication device from other devices through the sidelink and/or for applying hierarchical synchronization. Moreover, embodiments of the invention provide a scalable, backward-compatible extension of LTE primary synchronization signal, which, while still carrying the user-ID, further enables identification of the synchronization source and application of hierarchical synchronization at the receiver communication device.

In a further implementation form of the first aspect, both the first signal and the second signal are configured to individually provide the receiver communication device at least with partial information for determining an identifier of the transmitter communication device. This provides for the technical advantage of being less prone to transmission errors.

In a further implementation form of the first aspect, the first signal and the second signal are orthogonal, in one or more of time, frequency, space or code. This provides for the technical advantage that the first signal and the second signal can be more easily distinguished by the receiver communication device, while using the same communication resource.

In a further implementation form of the first aspect, the second signal is the complex conjugate of the first signal. This provides for the technical advantage that the first signal and the second signal can be more easily distinguished by the receiver communication device with a significantly lower computational complexity.

In a further implementation form of the first aspect, the first and signal are based on Zadoff-Chu sequences with the same length L and different root indices u1 and u2.

In a further implementation form of the first aspect, the first root index u1 and the second root index u2 are prime numbers to the length L with u2=L−u1. This provides for the technical advantage that the first signal and the second signal can be more easily distinguished by the receiver communication device, because the second signal is the complex conjugate of the first signal.

In a further implementation form of the first aspect, the length L of the first Zadoff-Chu sequence is equal to 63, the first root index u1 of the first Zadoff-Chu sequence is equal to 26 and the second root index u2 of the second Zadoff-Chu sequence is equal to 37.

In a further implementation form of the first aspect, the additional synchronization information comprises information for hierarchically synchronizing the receiver communication device, in particular information about the synchronization source and/or a status of the synchronization source.

According to a second aspect embodiments relate to a corresponding method of operating a transmitter communication device configured for communication with a receiver communication device in a wireless communication network, wherein the method comprises the following steps: providing basic synchronization information by generating a communication frame comprising at least a first signal and a second signal for synchronizing the receiver communication device; and providing additional synchronization information on the basis of the first and/or the second signal by: arranging at least the first signal and the second signal in a pre-defined configuration in the communication frame; and/or selecting the first signal and the second signal from a set of pre-defined synchronization signals that differ in a generating code.

The method according to the second aspect can be performed by the transmitter communication device according to the first aspect of the invention. Further features of the method according to the second aspect of the invention result directly from the functionality of the transmitter communication device according to the first aspect of the invention and its different implementation forms.

According to a third aspect embodiments relate to a receiver communication device configured for communication with a transmitter communication device in a wireless communication network, the receiver communication device comprising: a communication interface configured to receive a communication frame from the transmitter communication device, wherein the communication frame comprises at least a first signal and a second signal providing basic synchronization information for synchronizing the receiver communication device; and a processor configured to obtain additional synchronization information from the communication frame, wherein the additional synchronization information is defined by: an arrangement of the first signal and the second signal in a pre-defined configuration in the communication frame; and/or a selection of the first and the second signal from a set of pre-defined synchronization signals that differ in a generating code.

In a further implementation form of the third aspect, the processor is configured to obtain the additional synchronization information on the basis of a cross-correlation.

In a further implementation form of the third aspect, the processor is configured to hierarchically synchronize the receiver communication device on the basis of the additional synchronization information obtained from the communication frame, in particular information about the synchronization source and/or a status of the synchronization source.

According to a fourth aspect embodiments relate to a corresponding method of operating a receiver communication device configured for communication with a transmitter communication device in a wireless communication network, the method comprising the following steps: receiving a communication frame from the transmitter communication device, wherein the communication frame comprises at least a first signal and a second signal providing basic synchronization information for synchronizing the receiver communication device; and obtaining additional synchronization information from the communication frame wherein the additional synchronization information is defined by an arrangement of the first signal and the second signal in a pre-defined configuration in the communication frame; and/or a selection of the first and the second signal from a set of pre-defined synchronization signals that differ in a generating code.

The method according to the fourth aspect can be performed by the receiver communication device according to the third aspect of the invention. Further features of the method according to the fourth aspect of the invention result directly from the functionality of the receiver communication device according to the third aspect and its different implementation forms.

According to a fifth aspect embodiments relate to a computer program product, comprising computer executable instructions stored on a non-transitory computer-readable medium, wherein when the instructions are executed on a computer or a processor, causes the processor to perform the method according to the second aspect or the method according to the fourth aspect.

The invention can be implemented in hardware and/or software.

### BRIEF DESCRIPTION OF DRAWINGS

Further embodiments will be described with respect to the following figures, wherein:

FIG. 1 shows a schematic diagram illustrating a wireless communication network comprising a transmitter communication device according to an embodiment and a receiver communication device according to an embodiment;

FIGS. 2a, 2b and 2c show a respective schematic diagram illustrating several communication frames communicated between a transmitter communication device according to an embodiment and a receiver communication device according to an embodiment;

FIG. 3 shows a schematic diagram illustrating an exemplary hierarchical synchronization scheme implemented in a receiver communication device according to an embodiment;

FIG. 4 shows a schematic diagram illustrating processing steps implemented in a receiver communication device according to an embodiment;

FIG. 5 shows a diagram illustrating the respective results of a cross-correlation performed by a receiver communication device according to an embodiment;

FIG. 6 shows a table illustrating different types of synchronization information provided by a transmitter communication device according to an embodiment;

FIG. 7 shows a flow diagram illustrating processing steps implemented in a receiver communication device according to an embodiment;

FIG. 8 shows a flow diagram illustrating processing steps implemented in a receiver communication device according to an embodiment;

FIG. 9 shows a schematic diagram illustrating processing steps implemented in a receiver communication device according to an embodiment;

FIG. 10 shows a flow diagram illustrating a method of operating a transmitter communication device according to an embodiment; and

FIG. 11 shows a flow diagram illustrating a method of operating a receiver communication device according to an embodiment.

In the various figures, identical reference signs will be used for identical or at least functionally equivalent features.

### DESCRIPTION OF EMBODIMENTS

In the following description, reference is made to the accompanying drawings, which form part of the disclosure, and which show, by way of illustration, specific aspects of embodiments of the present invention. It is understood that other aspects may be utilized and structural or logical changes may be made without departing from the scope of the present invention. The following detailed description, therefore, is not to be taken in a limiting sense, as the scope of the present invention is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

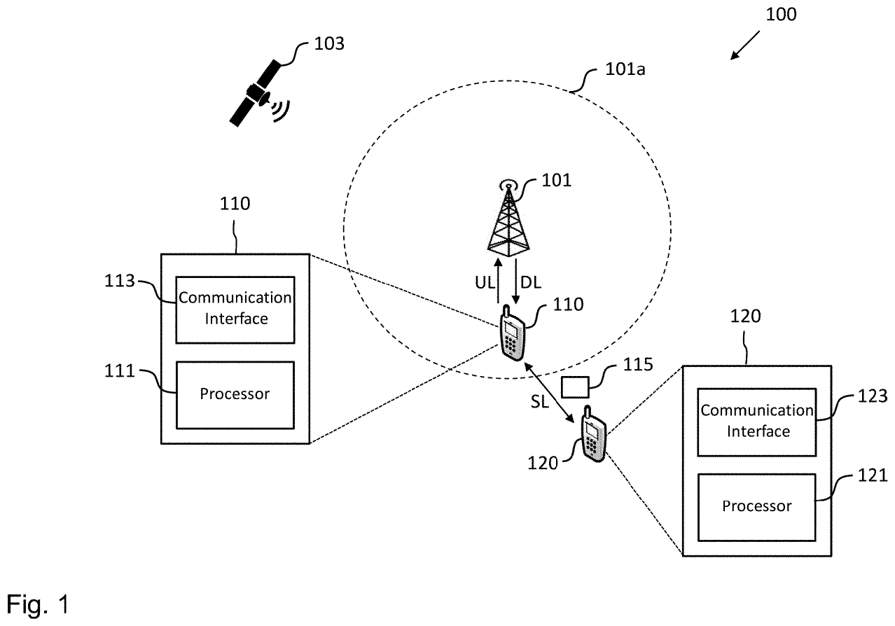

FIG. 1 shows a schematic diagram illustrating a wireless communication network 100 comprising a transmitter communication device 110 according to an embodiment and a receiver communication device 120 according to an embodiment. As indicated in FIG. 1, the transmitter communication device 110 and the receiver communication device 120 can be implemented in the form of user equipments (UEs), in particular mobile phones.

As indicated in FIG. 1, the wireless communication network 100 can further comprise a plurality of base stations 101 (only one base station 101 shown in figure for the sake of clarity), wherein each base station 101 defines a coverage area 101a. In the exemplary scenario shown in FIG. 1, the transmitter communication device 110 is located within the coverage area 101a of the base station 101 and, thus, can communicate with the base station 101 in an uplink (UL) and a downlink (DL) direction. Moreover, by way of example, the receiver communication device 120 is located outside of the coverage area 101a of the base station 101 and, thus, cannot communicate with the base station 101, but can communicate with the transmitter communication device 110 in a sidelink (SL) direction. The wireless communication network 100 can further comprise one or more satellites 103 of a global navigation satellite system (GNSS) configured to provide synchronization signals to the transmitter communication device 110 and/or the receiver communication device 120.

In the embodiment shown in FIG. 1, the transmitter communication device 110 comprises a processor 111 and a communication interface 113 and the receiver communication device 120 comprises a processor 121 and a communication interface 123.

As will be described in more detail further below, the processor 111 of the transmitter communication device 110 is configured to provide basic synchronization information by generating a communication frame 115 comprising at least a first signal and a second signal for synchronizing the receiver communication device 120. The processor 111 of the transmitter communication device 110 is further configured to provide additional synchronization information on the basis of the first and/or the second signal (i) by arranging at least the first signal and the second signal in a pre-defined configuration in the communication frame 115 and/or (ii) by selecting the first and the second signal from a set of pre-defined synchronization signals that differ in a generating code. The communication interface 113 of the transmitter communication device 113 can be configured to transmit the communication frame 115 to the receiver communication device 120.

The communication interface 123 of the receiver communication device 120 is configured to receive the communication frame 115 from the transmitter communication device 110, wherein the communication frame comprises the first signal and the second signal providing basic synchronization information for synchronizing the receiver communication device 120. As will be described in more detail further below, the processor 121 of the receiver communication device 120 is configured to obtain additional synchronization information from the communication frame 115, wherein the additional synchronization information is defined (i) by an arrangement of the first signal and the second signal in a pre-defined configuration in the communication frame 115 and/or (ii) by a selection of the first and the second signal from a set of pre-defined synchronization signals that differ in a generating code.

In an embodiment, the first signal and/or the second signal can be, for instance, reference signals, pilot signals and/or synchronization signals. In an embodiment, the communication frame 115 can comprise more than two signals. In an embodiment, the set of pre-defined synchronization signals comprises two or more than two pre-defined synchronization signals. In an embodiment, the set of pre-defined synchronization signals can depend on the receiver communication device 120, i.e. the transmitter communication device 110 can use a different set of pre-defined synchronization signals for different receiver communication devices 120.

In an embodiment the pre-defined synchronization signals can be based on LTE primary synchronization signals. Current cellular 3GPP LTE specifications provide a set of primary and secondary synchronization signals, namely PSSS/SSSS for the sidelink (for the general (i.e. non sidelink) case the primary and secondary synchronization signal are also referred to as “PSS” and “SSS” in the following). The user-ID contained in two integer parts is included in these sequences, where the first segment is in the PSSS and the second segment is in the SSSS. The PSSS consists of two identical parts, which are mapped on two consecutive OFDM symbols.

In an embodiment, the pre-defined synchronization signals are based on 63-length Zadoff-Chu (ZC) sequences. For a PSSS the particular root index identifies the sequence and the first segment of the user-ID, which indicates whether the user ID lies within the range {0, . . . , 167} or the range {168, . . . , 335}. In an embodiment, two predefined root indices, preferably 26 and/or 37, are used.

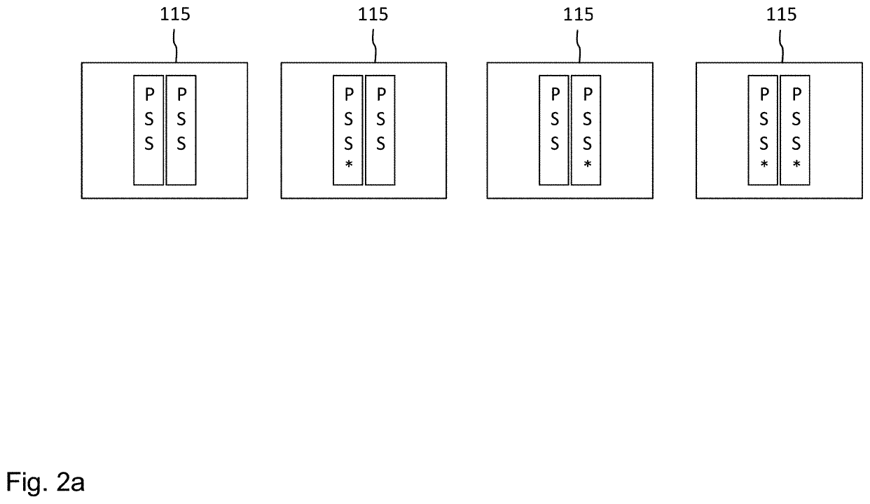

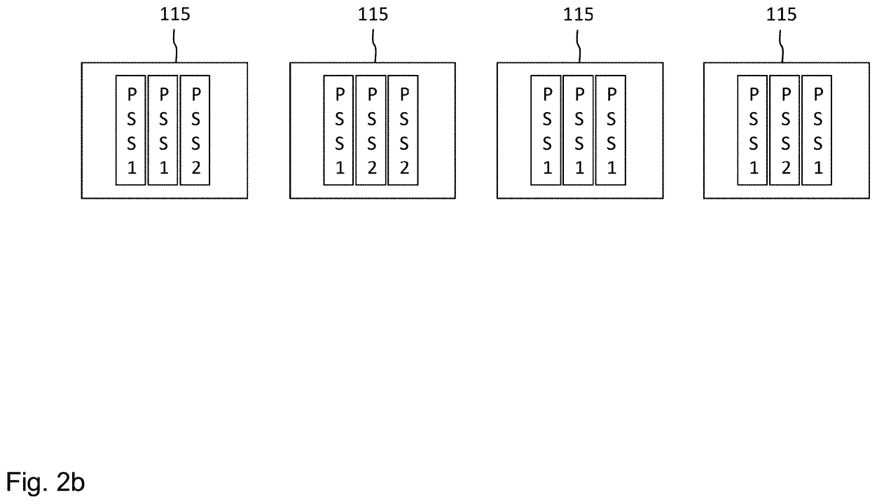

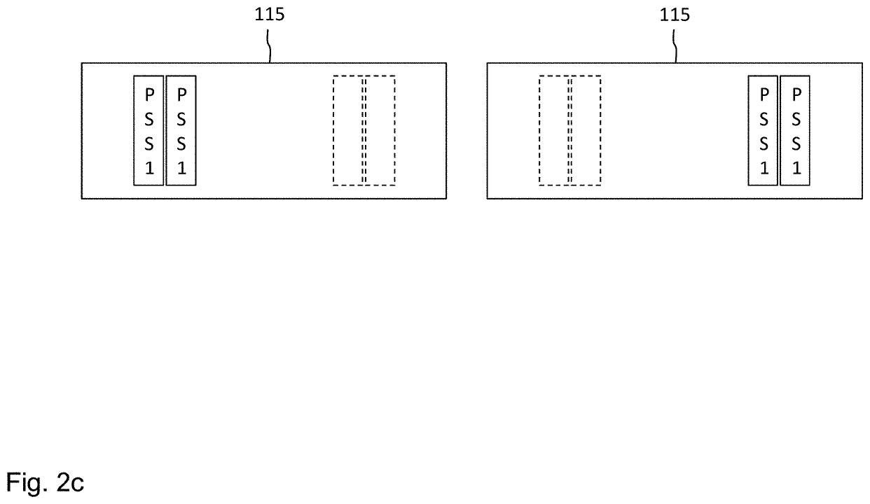

FIGS. 2a, 2b and 2c show exemplary communication frames 115 generated by the transmitter communication device 110 for encoding additional synchronization information therein.

FIG. 2a shows four exemplary communication frames 115, where the processor 111 of the transmitter communication device 110 is configured to provide additional synchronization information on the basis of the first or the second signal by selecting the first and the second signal from a set of pre-defined synchronization signals that differ in a generating code (in particular generating sequence). In the example shown in FIG. 2a the set of pre-defined synchronization signals contains a primary synchronization signal (PSS), such as a conventional LTE PSS, and its complex conjugate (PSS*). As will be appreciated, the additional synchronization information provided by the respective communication frames 115 shown in FIG. 2a could be expressed as the bit sequences “00”, “10”, “01” and “11”. By using a complex-valued PSS and its complex conjugate PSS* a cross-correlation-based detection performed by the receiver communication device 120 will be computationally more efficient. Moreover, the exemplary scheme illustrated in FIG. 2a comes with no additional overhead with the standard LTE synchronization scheme with two PSS in the LTE communication frame.

FIG. 2b shows four exemplary (out of eight possible) communication frames 115, wherein, as in the case of the example shown in FIG. 2a, the processor 111 of the transmitter communication device 110 is configured to provide additional synchronization information on the basis of the first or the second signal by selecting the first and the second signal from a set of pre-defined synchronization signals that differ in a generating code (in particular generating sequence). In the example shown in FIG. 2b the set of pre-defined synchronization signals contains a first primary synchronization signal (PSS1) and a second primary synchronization signal (PSS2) and the communication frame 115 comprises in addition to the first signal and the second signal a third signal allowing to encode more additional synchronization information. As can be taken from FIG. 2b, in this example the communication frame 115 provides three slots, wherein each slot is to be filed by the processor 111 of the transmitter communication device 110 either with PSS1 or with PSS2. As will be appreciated, the additional synchronization information provided by the exemplary communication frames 115 shown in FIG. 2n could be expressed as the bit sequences “001”, “011”, “000” and “010”, respectively.

FIG. 2c shows two exemplary communication frames 115, where the processor 111 of the transmitter communication device 110 is configured to provide additional synchronization information on the basis of the first or the second signal by arranging at least the first signal and the second signal in a pre-defined configuration in the communication frame 115. In the example shown in FIG. 2c the first and the signal are the same primary synchronization signal (PSS1) and the processor 111 of the transmitter communication device 110 is configured to arrange each of the first signal and the second signal in one of four possible slots. Thus, in the communication frame 115 on the left of FIG. 2c the first signal and the second signal are arranged in a first pre-defined configuration and in the communication frame 115 on the right the first signal and the second signal are arranged in a second pre-defined configuration. As will be appreciated, for the receiver communication device 120 the first pre-defined configuration can mean different additional synchronization information the second pre-defined configuration.

As already described above, the pre-defined synchronization signals can be based on LTE primary synchronization signals. Thus, in an embodiment both the first signal and the second signal are configured to individually provide the receiver communication device 120 at least with partial information for determining an identifier (user-ID) of the transmitter communication device 110.

As already described above, in an embodiment the first signal is based on a first Zadoff-Chu sequence and the second signal is based on a second Zadoff-Chu sequence. In an embodiment, the first Zadoff-Chu sequence is defined by a length L and a first root index u1 and the second Zadoff-Chu sequence is defined by a length L and a second root index u2 with u2 =L−u1. In an embodiment, the length L of the first Zadoff-Chu sequence is equal to 63, the first root index u1 of the first Zadoff-Chu sequence is equal to 26 and the second root index u2 of the second Zadoff-Chu sequence is equal to 37.

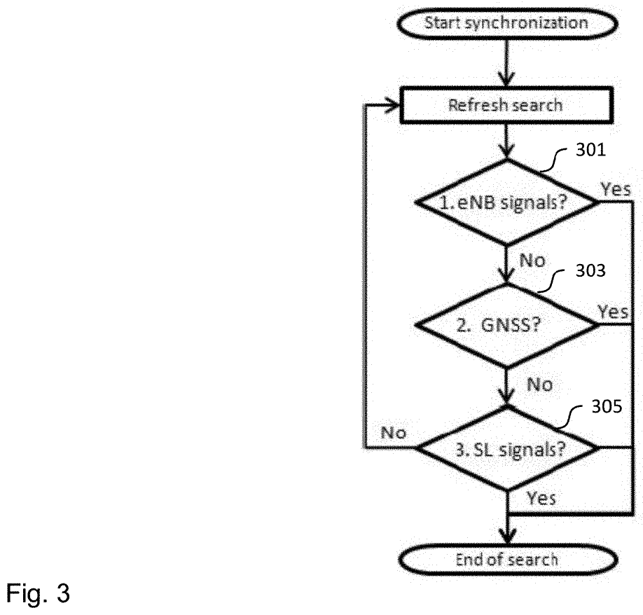

FIG. 3 shows a schematic diagram illustrating a hierarchical synchronization scheme implemented in the receiver communication device 120 according to an embodiment. In case the receiver communication device 120 is within the coverage area 101a of the base station 101 (i.e. the serving eNB), the receiver communication device 120 can detect downlink synchronization signals from the base station 101 (step 301) and perform synchronization on the basis there. In the absence of cellular coverage, the receiver communication device 120 can try to detect synchronization signals from the GNSS 103 (step 303). If the GNSS reference is not available, the out-of-coverage receiver communication device 120 can synchronize through sidelink synchronization signals sent by other in- or out-of-coverage communication devices (step 305), such as the transmitter communication device 110. In order to better align with nearby communication devices, it can be advantageous to synchronize not only to a single source, but to combine signals from multiple sources. In order to apply a hierarchical selection/combination, as shown in FIG. 3, additional synchronization information, such as information about the type of the synchronization source and the number of hops between the initial source and the transmitter communication device 110 are advantageously transmitted to the receiver communication device, as provided by embodiments of the invention.

An example of the additional synchronization information, which may be encoded by the transmitter communication device 110 in the communication frame 115 is provided in the following, wherein the transmitter communication device 110 is implemented in the form of a user equipment (UE) 110:
1. UE 110 follows base station (BS) 101 reference
a. BS 101 uses reference type A (e.g. GNSS 103)
i. UE 110 obtains reference directly from BS 101 (in-coverage)
ii. UE 110 obtains reference from another (in-coverage) UE
b. BS 101 uses reference type B (e.g. network-based synchronization)
i. UE 110 obtains reference directly from BS 101 (in-coverage)
ii. UE 110 obtains reference from another (in-coverage) UE
2. UE 110 follows GNSS 103 reference
a. UE 110 has GNSS 103 reference of type A (e.g. GPS)
i. UE 110 obtains reference directly from GNSS 103 (in-coverage)
ii. UE 110 obtains reference form another UE with GNSS 103
b. UE 110 has GNSS 103 reference of type B (e.g. Galileo)
i. UE 110 obtains reference directly from GNSS 103 (in-coverage)
ii. UE 110 obtains reference from another UE with GNSS 103

As will be appreciated, the above additional synchronization information can be encoded by the transmitter communication device 110, for instance, on the basis of one or more of the examples shown in FIGS. 2a, 2b and 2c.

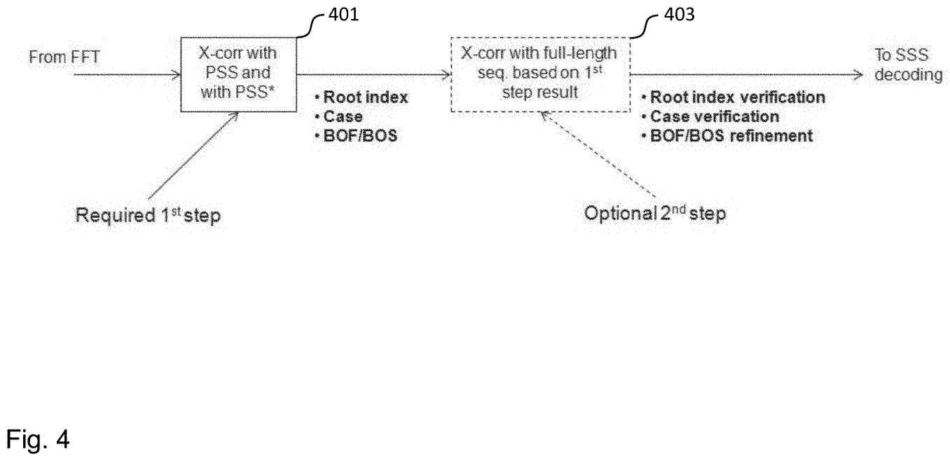

FIG. 4 shows a schematic diagram illustrating processing steps implemented in the receiver communication device 120 according to an embodiment. More specifically, FIG. 4 illustrates the sequence detection at the receiver communication device 120. In a first stage 401, a cross-correlation (x-corr) is performed to identify which sequence (built by a combination of PSS or PSS*) is sent. The case is identified and the BOF/BOS is detected at the same time. In a second stage 403, a cross-correlation with the full detected sequence from the first stage can be performed to validate and refine the estimation.

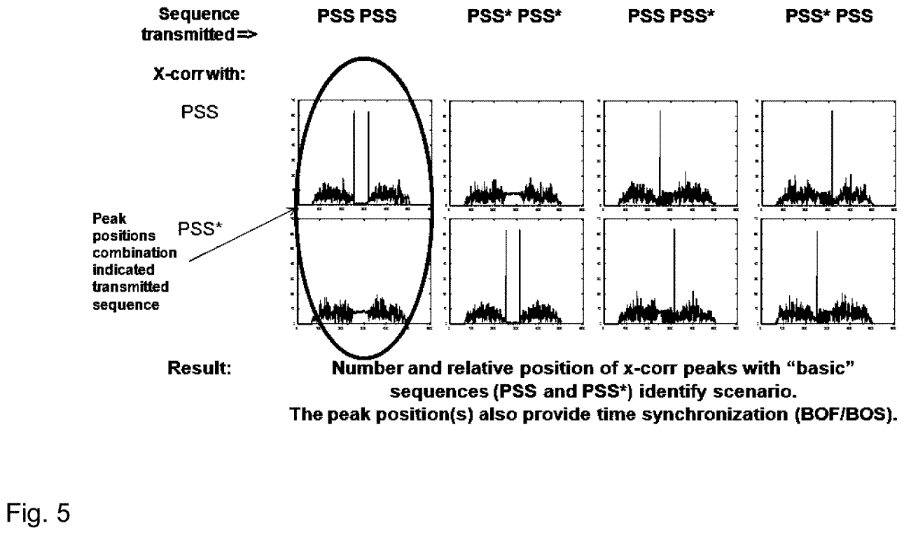

FIG. 5 shows the result of the first and second stage correlations for different combinations of transmitted signal for the two-segment signal (n=2). The peak positions combination in the first stage 401 already indicates which sequences have been received, which identifies the case. At the same time, time synchronization can be performed. In the second stage 403, the correlation with the full sequence verifies the estimate and refines it. Possible imperfections and errors from the first stage 401 can be also detected here. In both first and second stages, if detection is successful, there is no uncertainty about the transmitted sequence; hence all the information can be obtained by the receiver communication device 120.

A further example of the additional synchronization information, which may be encoded by the transmitter communication device 110 in the communication frame 115 is provided in the following, wherein the transmitter communication device 110 is implemented in the form of a user equipment (UE) 110:
1. User-ID, its first part, i.e. whether it lies in {0, . . . , 167} or {168, . . . , 335}.
2. UE 110 uses the cellular network, i.e. base station 101 reference
   Directly (in cellular coverage)
   Over another UE in cellular coverage
3. UE 110 uses GNSS 103 reference
   Directly (with own GNSS link)
   Over another UE with a GNSS link

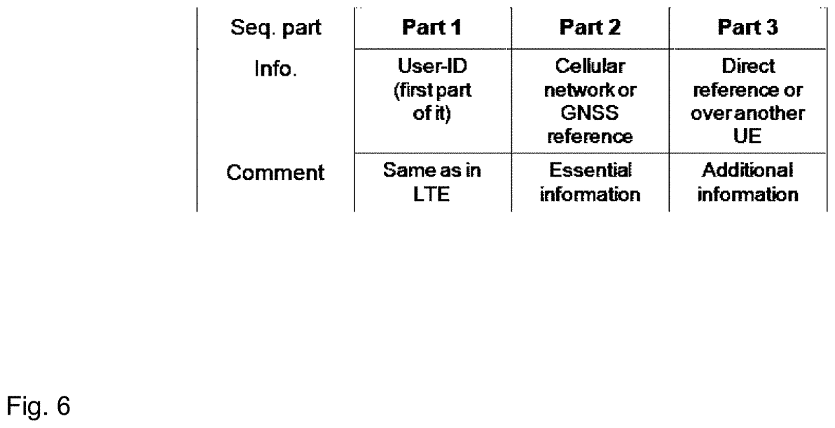

This results in the scheme shown in FIG. 6. The benefit of the scheme is that it allows for one-by-one parameter detection and, as described in the following, backwards compatibility with legacy LTE signals and UEs.

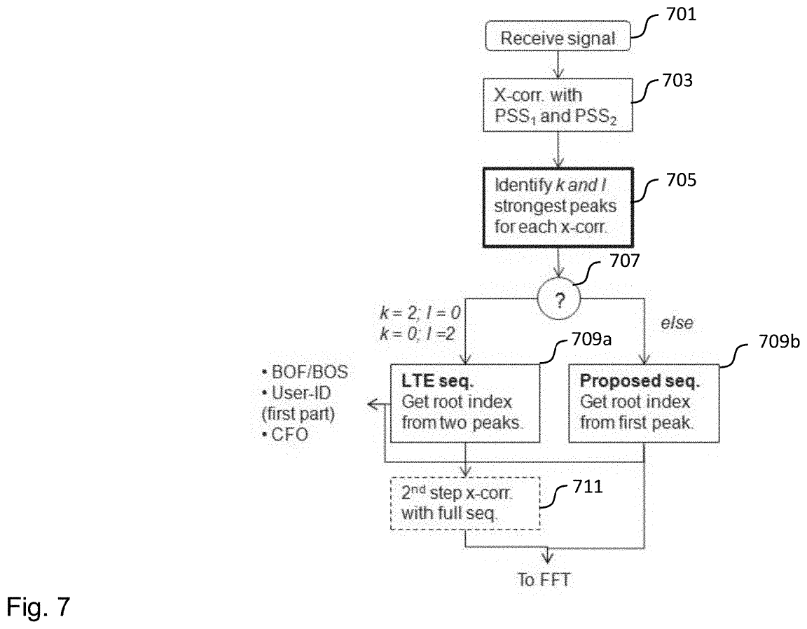

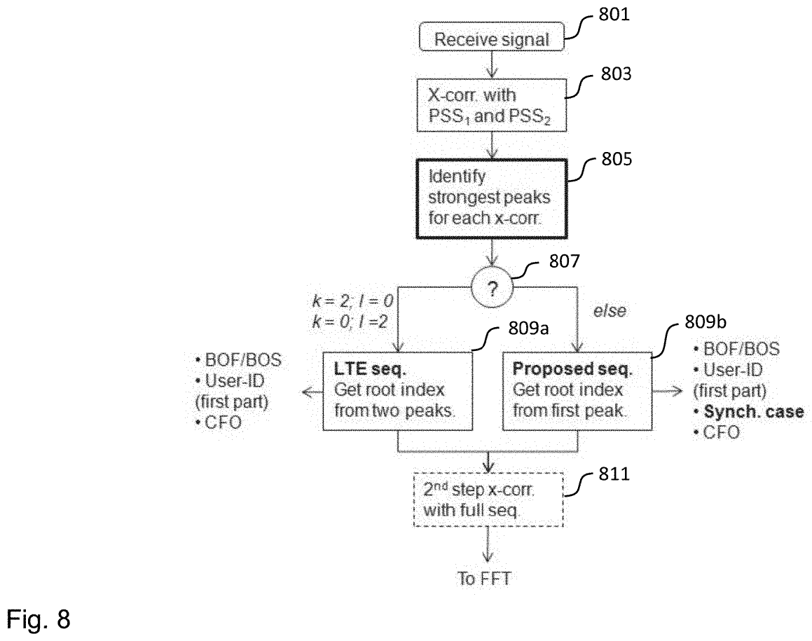

The search procedure followed by the receiver communication device 120 according to an embodiment and a LTE legacy UE to detect signals and obtain the above information is explained by the flow diagrams shown in FIGS. 7 and 8, respectively. In both FIGS. 7 and 8, the decision point 707/807 is important, where the receiver communication device 120 decides what type of synchronization sequences it has received (LTE or advanced) and acquires the corresponding information from these sequences. Steps 701 to 705 of FIG. 7 and steps 801 to 805 of FIG. 8 illustrate the correlation-based peak detection, whereas step 709/809 refers to the parameter extraction and the optional step 711/811 allows for a refinement of the preceding steps (peak refinement).

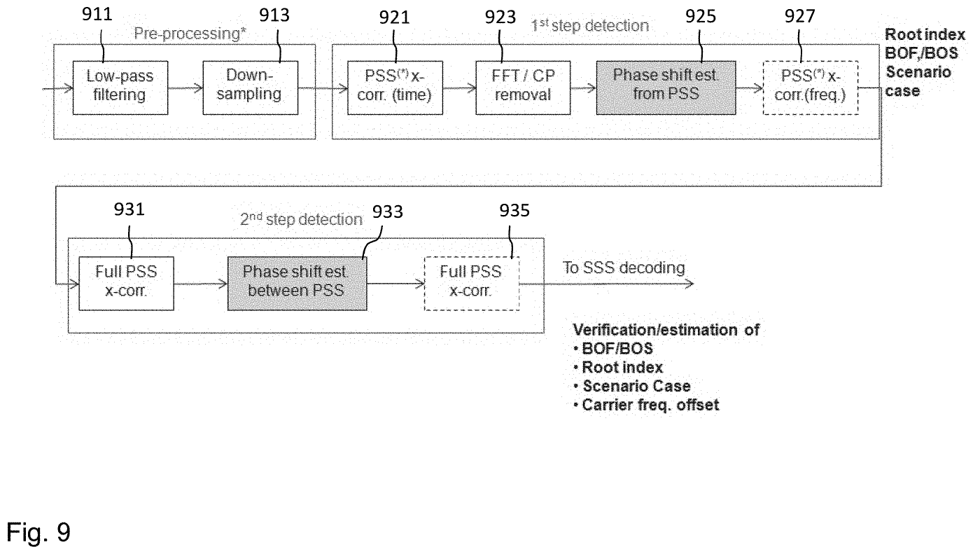

FIG. 9 shows a schematic diagram illustrating processing steps implemented in the receiver communication device 120 according to an embodiment. More specifically, FIG. 9 illustrates an implementation of the two-stage detection at the receiver communication device 120. In addition to pre-processing steps 911, 913 and the basic cross-correlation based operations (steps 921, 923 and 927 and steps 931 and 935), which have been already described above, it is advantageous to perform the additional steps highlighted in grey, namely steps 925 and 933. In these steps, the phase shifts estimated due to time/frequency offsets can be compensated, before the operation is performed again (processing blocks with dashed lines, i.e. steps 927 and 935). This allows validating and refining the initial estimates and provides a less-distorted signal to the next steps of the signal processing chain.

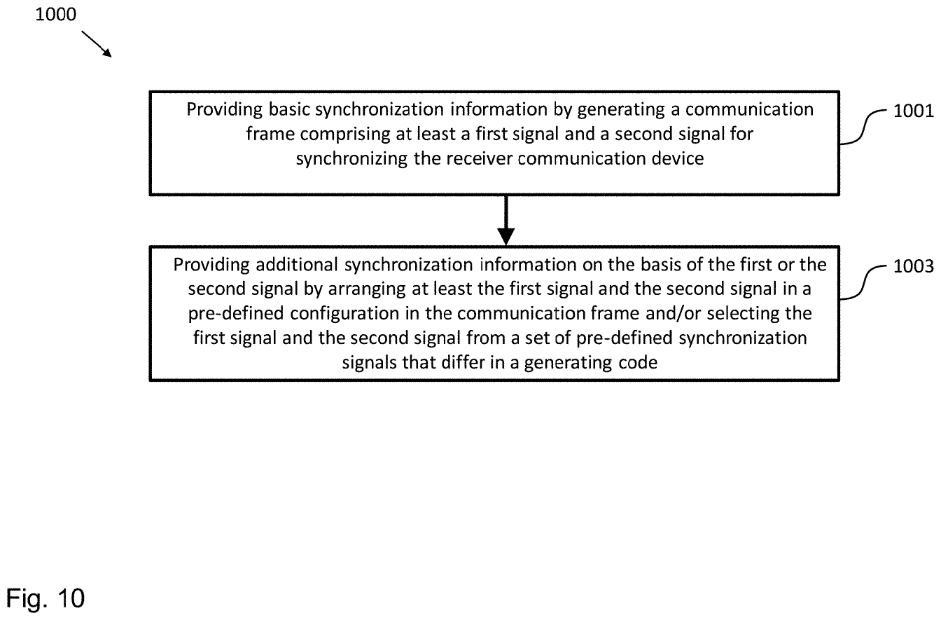

FIG. 10 shows a flow diagram illustrating a method 1000 of operating the transmitter communication device 110 according to an embodiment. The method 1000 comprises the steps of providing 1001 basic synchronization information by generating a communication frame 115 comprising at least a first signal and a second signal for synchronizing the receiver communication device 120 and providing 1003 additional synchronization information on the basis of the first or the second signal by: arranging at least the first signal and the second signal in a pre-defined configuration in the communication frame 115 and/or selecting the first signal and the second signal from a set of pre-defined synchronization signals that differ in a generating code.

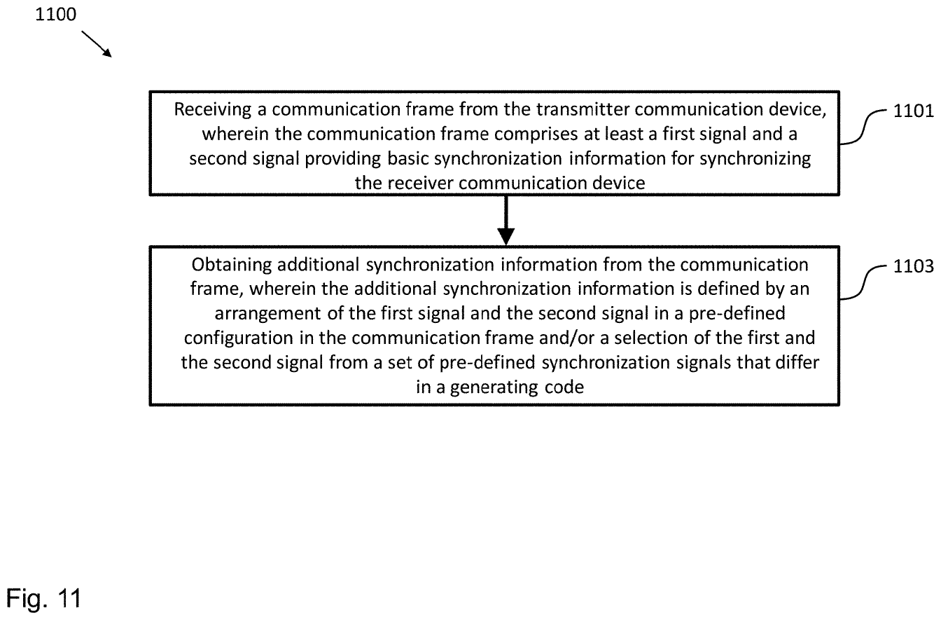

FIG. 11 shows a flow diagram illustrating a method 1100 of operating the receiver communication device 120 according to an embodiment. The method comprises the steps of receiving 1101 a communication frame 115 from the transmitter communication device 110, wherein the communication frame 115 comprises at least a first signal and a second signal providing basic synchronization information for synchronizing the receiver communication device 120 and obtaining 1103 additional synchronization information from the communication frame 115, wherein the additional synchronization information is defined by an arrangement of the first signal and the second signal in a pre-defined configuration in the communication frame and/or a selection of the first and the second signal from a set of pre-defined synchronization signals that differ in a generating code.

Embodiments of the invention provide a novel scheme for generating hierarchically structured sequences, which can be used to distinguish between different cases, e.g. synchronization status of a transmitting UE. Sequences with n segments, where each segment is chosen from a set of two possible subsequences, can identify 2n different cases by checking whether that sequence has been received or not (binary decision: yes/no). Moreover, by defining one segment as the complex conjugate of the other one, computational complexity of correlation-based detection procedures can be significantly reduced. In order align with the LTE framework, the already involved Zadoff-Chu sequences can be used for constructing sidelink synchronization signals. By choosing root indices for first and second segment as described above, orthogonality between subsequences can be obtained. Finally, backward compatibility for legacy transmitting and receiving UEs is maintained, while more advanced UEs can take advantage of the proposed sequences and extract additional information.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present invention has been described with reference to one or more particular embodiments, those skilled in the art recognize that many changes may be made thereto without departing from the scope of the present invention. It is therefore to be understood that within the scope of the appended claims and their equivalents, the invention may be practiced otherwise than as specifically described herein.

1. A transmitter communication device configured for communication with a receiver communication device in a wireless communication network, wherein the transmitter communication device comprises:
a processor configured to provide basic synchronization information by generating a communication frame comprising at least a first signal and a second signal for synchronizing the receiver communication device, wherein the processor is further configured to provide additional synchronization information on the basis of the first and/or the second signal by:
arranging at least the first signal and the second signal in a pre-defined configuration in the communication frame; and/or
selecting the first and the second signal from a set of pre-defined synchronization signals that differ in a generating code.

2. The transmitter communication device of claim 1, wherein the first signal and the second signal are configured to individually provide the receiver communication device at least with partial information for determining an identifier of the transmitter communication device.

3. The transmitter communication device of claim 1, wherein the first signal and the second signal are orthogonal in one or more of time, frequency, space or code.

4. The transmitter communication device of claim 1, wherein the second signal is a complex conjugate of the first signal.

5. The transmitter communication device of claim 1, wherein the first and second signal are based on Zadoff-Chu sequences with same length L and different root indices u1 and u2.

6. The transmitter communication device of claim 5, wherein a first root index u1 and a second root index u2 are prime numbers to the length L with u2=L−u1.

7. The transmitter communication device of claim 6, wherein the length L is equal to 63, the first root index u1 is equal to 26 and the second root index u2 is equal to 37.

8. The transmitter communication device of claim 1, wherein the additional synchronization information comprises information for hierarchically synchronizing the receiver communication device.

9. A method of operating a transmitter communication device configured for communication with a receiver communication device in a wireless communication network, wherein the method comprises:
providing basic synchronization information by generating a communication frame comprising at least a first signal and a second signal for synchronizing the receiver communication device; and
providing additional synchronization information on the basis of the first and/or the second signal by:
arranging at least the first signal and the second signal in a pre-defined configuration in the communication frame; and/or
selecting the first signal and the second signal from a set of pre-defined synchronization signals that differ in a generating code.

10. The method of claim 9, Wherein the first signal and the second signal are configured to individually provide the receiver communication device at least with partial information for determining an identifier of the transmitter communication device.

11. The method of claim 9, wherein the first signal and the second signal are orthogonal in one or more of time, frequency, space or code.

12. The method of claim 9, wherein the second signal is a complex conjugate of the first signal.

13. The method of claim 9, wherein the first and second signal are based on Zadoff-Chu sequences with same length L and different root indices u1 and u2.

14. The method of claim 13, wherein a first root index u1 and a second root index u2 are prime numbers to the length L with u2=L−u1.

15. The method of claim 14, wherein the length L is equal to 63, the first root index u1 is equal to 26 and the second root index u2 is equal to 37.

16. The method of claim 9, wherein the additional synchronization information comprises information for hierarchically synchronizing the receiver communication device.

17. A receiver communication device configured for communication with a transmitter communication device in a wireless communication network, the receiver communication device comprising:
a communication interface configured to receive a communication frame from the transmitter communication device, wherein the communication frame comprises at least a first signal and a second signal providing basic synchronization information for synchronizing the receiver communication device; and
a processor configured to obtain additional synchronization information from the communication frame, wherein the additional synchronization information is defined by:
an arrangement of the first signal and the second signal in a pre-defined configuration in the communication frame; and/or
a selection of the first and the second signal from a set of pre-defined synchronization signals that differ in a generating code.

18. The receiver communication device of claim 17, wherein the processor is configured to obtain the additional synchronization information on the basis of a cross-correlation.

19. The receiver communication device of claim 17, wherein the processor is configured to hierarchically synchronize the receiver communication device on a basis of the additional synchronization information obtained from the communication frame.

20. A non-transitory computer-readable storage medium comprising computer executable instructions, which when executed cause a transmitter to perform a method of communicating with a receiver in a wireless communication network, the method comprising:
providing basic synchronization information by generating a communication frame comprising at least a first signal and a second signal for synchronizing the receiver; and
providing additional synchronization information on the basis of the first and/or the second signal by:
arranging at least the first signal and the second signal in a pre-defined configuration in the communication frame; and/or
selecting the first signal and the second signal from a set of pre-defined synchronization signals that differ in a generating code.
